(19) United States
(12) Patent Application Publication
(10) Pub. No.: US 2026/0366281 A1
(43) Pub. Date: Nov. 19, 2026

(54) WASTE DISPOSER SYSTEM INCLUDING INTEGRATED POWER RECEPTACLE

(71) Applicant: INSINKERATOR LLC, Benton Harbor, MI (US)

(72) Inventors: Jeffrey S. Ward, Kenosha, WI (US); Thomas Lefeber, Mount Pleasant, WI (US)

(21) Appl. No.: 19/132,279

(22) PCT Filed: Nov. 30, 2023
(86) PCT No.: PCT/US2023/081969

§ 371 Date: May 22, 2025

Related U.S. Application Data
(60) Provisional application No. 63/429,792, filed on Dec. 2, 2022.

(51) Int. Cl. E03C 1/266; B02C 25/00; E03C 1/044

(52) U.S. Cl. CPC E03C 1/2665; B02C 25/00; E03C 1/044; B02C 2201/063

(57) ABSTRACT

Waste disposer systems, such as food waste disposer systems, including integrated air switch mechanisms, and combination systems including such disposer systems, and related methods, are disclosed herein. In one example embodiment, a food waste disposer system includes a power control module and a motor supported at least partly within a housing. Further, the disposer system includes an actuator, at least one communication linkage, and an electrical socket, and is configured to receive a power link that extends outward from the housing, so that the module is coupled electrically, at least indirectly, to an end of the power link. First electric power received via the power link is communicated from the power link to the motor when the module has a first operational status, and second electric power received via the power link is communicated, at least indirectly, to the electrical socket when the module has a second operational status.

### FIELD

The present disclosure relates to waste disposers such as food waste disposers and, more particularly, to control systems and/or power systems for use in or in conjunction with such waste disposers or associated devices, as well as to waste disposers comprising such control and/or power systems, and to methods of assembling and/or operating control and/or power systems in relation to waste disposers or associated devices.

### BACKGROUND

Food waste disposers are used to comminute food scraps into particles small enough to pass through household drain plumbing. Such food waste disposers can be powered in several manners depending upon the embodiment or environment. Most older homes (pre-1970's) have a Romex/BX cable extending from a wall of the home, which can be coupled and terminated directly to the disposer in a hardwired manner. However, most newer homes have a standard electrical power outlet (e.g., a wall outlet) near the disposer, to which the disposer can be coupled by way of a power cord and associated plug so as to receive power. Out of all homes, it is estimated that around half of homes with a disposer have hardwiring and that most remaining homes use a power outlet located in the sink cabinet (these proportions are changing over time).

In many installations of food waste disposers, whether power is provided to the disposer (or whether the disposer is switched on or off) can be determined by way of a built-in wall switch. Such installations can include ones in which the disposers are installed via hardwiring including a Romex/BX cable as well as ones in which the disposers are coupled to an electrical power outlet by way of a power cord and associated plug. In such installations, whether power is made available to the food waste disposer, via the Romex/BX cable or via the electric power outlet and power cord and plug as the case may be, is determined based upon the status of the wall switch.

However, in other installations, whether power is provided to the disposer (or whether the disposer is switched on or off) is determined by way of an additional operator-controllable switching mechanism other than (or in addition to) a built-in wall switch. In some such embodiments, a food waste disposer is implemented in conjunction with an aftermarket air switch power control device by which an operator can control the provision of power to the disposer (or whether the disposer is switched on or off). The air switch power control device includes a power control module linked to an operator-actuatable push button by way of an air conduction tube. The power control module has an electrical power outlet into which the plug of a power cord of the disposer can be plugged. The operator-actuatable push button can take any of a variety of forms including, for example, a deformable bulbous rubber structure, such that depression of the push button causes air to flow through the air conduction tube away from the push button toward and to the power control module. Further, the air switch power control device also includes a power cord extending between the power control module and an associated plug, which can be plugged into another electrical power outlet such as a wall outlet.

Such an air switch power control device is configured to have two operational states. In a first one of the operational states, the electric power received via the power cord of the air switch power control device, which is coupled to the wall outlet, is in turn communicated to the electrical power outlet of the power control module itself. In this first operational state, any food waste disposer coupled to the electrical power outlet of the power control module (e.g., coupled by way of a power cord of the disposer itself) can receive electric power and be switched on. Also, in a second one of the operational states, the electric power outlet of the power control module is decoupled electrically from the power cord of the air switch power control device. In this second operational state, no power from the wall outlet is provided at the electric power outlet of the power control module, and thus any food waste disposer coupled to the electrical power outlet of the power control module cannot receive power and is switched off.

Whether the air switch power control device is in the first operational state or in the second operational state depends upon operator actuation of the operator-actuatable push button. More particularly, upon being pressed by an operator, the operator-actuatable push button causes air to be forced away from the push button through the air conduction tube to the power control module, which includes a sensor that detects changes in air pressure flow (or pressure). Further, upon detecting a change in air pressure flow (or pressure), the sensor produces a signal that causes (directly or indirectly) the status of the power control module to toggle between the two statuses respectively corresponding to the two operational states of the air switch power control device. In this manner, operator actuation of the operator-actuatable push button of the air switch power control device determines whether electric power received at the power control module from the wall outlet is provided to the electrical power outlet of the power control module and thus provided to power any disposer coupled to that electric power outlet.

Although such an air switch power control device enables an operator to control the provision of power from a wall outlet to a food waste disposer coupled to that air switch power control device, without the presence of a wall switch, there are several disadvantages associated with installations involving such an air switch power control device. In particular, implementation of such an air switch power control device can be unwieldy or awkward given the number of connections/linkages involved, including not only the power cord of the food waste disposer itself but also the power cord of the air switch power control device, in addition to the air conduction tube, and also insofar as it may be difficult to find a location (e.g., under a kitchen sink) at which the power control module can be situated/supported in a manner that accommodates these connections/linkages.

Further, in some circumstances, it is desirable for another device associated with the food waste disposer, such as a hot water heating device, to be implemented in proximity with the food waste disposer and to receive power from the same source as the food waste disposer itself. To accommodate such an implementation, in some embodiments an air switch power control device will have a power control module having two electrical power outlets, such that a power cord of a food waste disposer can be plugged into one of the electrical power outlets and a power cord of a hot water heating device (or other associated device) can be plugged into the other of the electrical power outlets. Yet such implementations, involving still an additional connection/linkage (e.g., the power cord of the hot water heating device or other associated device), can be even more unwieldy/awkward, especially insofar as it may be even more difficult to find a location at which the power control module can be appropriately situated/supported.

Additionally, it should be appreciated from the above discussion that a conventional air switch power control device such as that described above is particularly suited for implementation in relation to a food waste disposer that is configured to be coupled to a power source by way of a power cord and associated plug, which (instead of being directly coupled to a wall outlet) can be coupled to the electrical power outlet of the power control module of the air switch power control device. In this regard, therefore, such air switch power control devices are unsuitable for use in conjunction with food waste disposers that are configured to receive power in another manner (e.g., by hardwiring involving a Romex/BX cable).

For at least one or more of these reasons, or one or more other reasons, it would therefore be advantageous if improved control and/or power mechanisms or systems for use in or in conjunction with food waste disposers or other disposers and/or associated devices could be developed, and/or if improved food waste disposers or other disposers having or operating in conjunction with such improved control and/or power mechanisms or systems could be developed, and/or if improved methods of assembling and/or operating such mechanisms, systems, or disposers could be developed, so as to address any one or more of the concerns discussed above or to address one or more other concerns or provide one or more benefits.

### BRIEF SUMMARY

In at least some example embodiments, the present disclosure relates to a food waste disposer system. The food waste disposer system includes a housing including a bottom housing portion and a top housing portion, a power control module supported at least partly within the housing, and a motor supported within the housing and coupled electrically, at least indirectly, to the power control module. The food waste disposer system also includes an actuator, at least one communication linkage connecting the actuator with the power control module, and an electrical socket supported along the bottom housing portion and coupled electrically, at least indirectly, to the power control module. Either the bottom housing portion or the power control module is further configured to receive a first power link that extends outward from the housing, so that the power control module is coupled electrically, at least indirectly, to a first end of the first power link. Additionally, the power control module is configured to respond to at least one signal communicated via the at least one communication linkage occurring as a result of an actuation of the actuator, and further configured to switch between at least a first operational status and a second operational status in response to the at least one signal. Also, first electric power received via the first power link is communicated from the first power link via the power control module to the motor when the power control module has the first operational status, but not communicated from the first power link via the power control module to the motor when the power control module has the second operational status. Further, second electric power received via the first power link is communicated from the first power link via the power control module, at least indirectly, to the electrical socket at least when the power control module has the second operational status.

Additionally, in at least some example embodiments, the present disclosure relates to a food waste disposer system. The food waste disposer system includes a housing including a bottom housing portion and a top housing portion, and a power control module supported within the housing. Also, the food waste disposer system includes a motor supported within the housing and coupled electrically, at least indirectly, to the power control module. Further, the food waste disposer system includes an actuation button positioned externally of the housing, an air conduction tube connecting the actuation button at least indirectly with the power control module, and an electrical socket supported along the bottom housing portion and coupled electrically, at least indirectly, to the power control module. The bottom housing portion is further configured to receive a first power link that extends outward from the housing, so that the power control module is coupled electrically, at least indirectly, to a first end of the first power link. Additionally, the power control module is configured to respond to air flow or air pressure communicated through the air conduction tube occurring as a result of an actuation of the actuation button, and further configured to switch between at least a first operational status and a second operational status in response to the air flow or air pressure. Further, first electric power received via the first power link is communicated from the first power link via the power control module to the motor when the power control module has the first operational status, but not communicated from the first power link via the power control module to the motor when the power control module has the second operational status. Additionally, second electric power received via the first power link is communicated from the first power link via the power control module to the electrical socket both when the power control module has the first operational status and the second operational status.

Also, in at least some example embodiments, the present disclosure relates to a method. The method includes providing a food waste disposer system including a housing having a bottom housing portion and a top housing portion, a power control module supported at least partly within the housing, a motor supported within the housing and coupled electrically, at least indirectly, to the power control module, an actuator positioned externally of the housing, at least one communication linkage connecting the actuator with the power control module, and an electrical socket supported along the bottom housing portion and coupled electrically, at least indirectly, to the power control module. The power control module is coupled electrically, at least indirectly, to a first end of a first power link that is received either at the bottom housing portion or the power control module and that extends outward from the housing. Further, the method includes receiving first electric power and second electric power at the power control module via the first power link and, in response to an actuation of the actuator, communicating at least one signal via the at least one communication linkage. Also, the method includes switching between at least a first operational status of the power control module and a second operational status of the power control module at least indirectly in response to the at least one signal. The first electric power received via the first power link is communicated from the first power link via the power control module to the motor when the power control module has the first operational status, but not communicated from the first power link via the power control module to the motor when the power control module has the second operational status. Additionally, the second electric power received via the first power link is communicated from the first power link via the power control module, at least indirectly, to the electrical socket at least when the power control module has the second operational status.

Further, in at least some further example embodiments, the present disclosure relates to a method. The method includes providing a food waste disposer system including a housing including a bottom housing portion and a top housing portion, a power control module supported within the housing, a motor supported within the housing and coupled electrically, at least indirectly, to the power control module, an actuation button positioned externally of the housing, an air conduction tube connecting the actuation button at least indirectly with the power control module, and an electrical socket supported along the bottom housing portion and coupled electrically, at least indirectly, to the power control module. The power control module is coupled electrically, at least indirectly, to a first end of a first power link that is received at the bottom housing portion and extends outward from the housing. The method additionally includes receiving first electric power at the power control module via the first power link and, in response to an actuation of the actuation button, communicating an air flow or air pressure through the air conduction tube. The method further includes switching between at least a first operational status of the power control module and a second operational status of the power control module in response to the air flow or air pressure. First electric power received via the first power link is communicated from the first power link via the power control module to the motor when the power control module has the first operational status, but not communicated from the first power link via the power control module to the motor when the power control module has the second operational status. Also, second electric power received via the first power link is communicated from the first power link via the power control module to the electrical socket both when the power control module has the first operational status and the second operational status.

Additionally, in at least some additional example embodiments, the present disclosure relates to a waste disposer system including an integrated air switch arrangement. The waste disposer system has a waste disposer that includes a housing, a motor supported within the housing, a power control module supported within the housing, and either a receiving terminal coupled at least indirectly with the power control module by which the waste disposer can be connected to either a Romex cable or a BX cable to receive first electric power, or a first power cord coupled at least indirectly to the power control module by which the waste disposer can be coupled to a wall outlet to receive the first electric power. Further, the waste disposer system also includes an actuator and an air conduction tube linking the actuator with the power control module. The power control module includes at least one sensor by which the power control module can detect a change in air flow or air pressure as communicated by the air conduction tube in response to an actuation of the actuator and, upon detecting the change, switch between a first operational mode and a second operational mode. When the power control module is in the first operational mode and the first electric power is received by the waste disposer by either the receiving terminal or the first power cord, the first electric power is communicated at least indirectly by the power control module to both the motor and an additional structure included by the waste disposer, but when the power control module is in the second operational mode, the first electric power is not communicated by the power control module to at least one of the motor or the additional structure.

### BRIEF DESCRIPTION OF THE DRAWINGS

Embodiments of waste disposer systems (e.g., food waste disposer systems), waste disposers (e.g., food waste disposers), control systems for integration or implementation in combination with such disposer systems or disposers, combination systems including associated or auxiliary devices in addition to such disposer systems or disposers, and/or related methods, are disclosed with reference to the accompanying drawings and are for illustrative purposes only. The systems and methods encompassed herein are not limited in their applications to the details of construction, arrangements of components, or other aspects or features illustrated in the drawings, but rather such systems and methods encompassed herein include other embodiments or are capable of being practiced or carried out in other various ways. Like reference numerals are used to indicate like components. In the drawings:

FIG. 1 is a top, substantially front perspective view of a first example food waste disposer system having a first example food waste disposer and an integrated air switch arrangement, shown in combination with a first example associated or auxiliary device that is coupled to the food waste disposer to receive electric power therefrom and that in the present embodiment is a hot water heating device, where a power cord of the hot water heating device is also shown in an alternate position by phantom lines to reveal a plug associated with the power cord, and further showing the food waste disposer system and hot water heating device to be mounted and/or connected in relation to an example sink, portions of which are also shown by way of phantom lines;

FIG. 2 is a schematic view illustrating electrical and pneumatic components of the food waste disposer system of FIG. 1 including an electric socket, and how those components are coupled with one another in that food waste disposer system, along with a schematic view of an example auxiliary (or associated) device that can be coupled to the electric socket of the food waste disposer system so as to form an example combination system;

FIG. 3 is a bottom perspective cutaway view of a food waste disposer of the first example food waste disposer system of FIG. 1, shown independent of the sink and the hot water heating device and associated power cord of FIG. 1, and also shown without being coupled to, or having, any power link by which the food waste disposer system can receive electric power;

FIG. 4 is a bottom perspective cutaway view of portions of the food waste disposer of the first example food waste disposer system of FIGS. 1 and 3, in which is additionally shown an example power link (also shown in FIG. 1) by which the food waste disposer system can receive electric power;

FIG. 5 is a bottom perspective view of portions of a second example food waste disposer that, in addition to having an electrical outlet by which the food waste disposer can be coupled to a power cord of an associated or auxiliary device (such as the hot water heating device of FIG. 1), also includes a terminal by which the food waste disposer can be coupled to receive electric power, in either of two alternative manners depending upon whether the installation environment (e.g., home) within which the food waste disposer is installed includes a Romex/BX cable or a wall outlet;

FIG. 6 is a top perspective cutaway view of a portion of a lower end frame (LEF) and associated components of the second example food waste disposer of FIG. 5;

FIGS. 7A-7C show system components that can be selectively employed in or as part of (or in conjunction with) the second example food waste disposer of FIGS. 5 and 6 so as to achieve installation of the food waste disposer in either of the two alternative manners depending upon whether the installation environment (e.g., home) includes a Romex/BX cable or a wall outlet; and

FIG. 8 is a partly-exploded view of an assembly of a Romex/BX cable in relation to an adapter with custom plug shown in FIG. 7C, which can be employed so as to achieve installation of the second example food waste disposer of FIGS. 5 and 6 in a home having/providing the Romex/BX cable.

### DETAILED DESCRIPTION

The present disclosure relates to and encompasses waste disposer systems such as food waste disposer systems, as well as combination systems that include not only waste disposer systems but also associated or auxiliary devices such as hot water heating devices that are implemented or operated in combination with waste disposer systems. Further, the present disclosure relates to control systems or power systems included within, or integrated or utilized in conjunction with, such waste disposer systems, waste disposers thereof, or combination systems including such waste disposer systems, as well as to waste disposer systems or combination systems including such waste disposers systems that have integrated control systems or power systems or include or operate in conjunction with control systems or power systems.

More particularly in this regard, the present inventors have recognized that an improved food waste disposer system in at least some embodiments will include an air switch power control device or arrangement that is integrated with a food waste disposer of the food waste disposer system, where such integration particularly involves positioning a power control module of the air switch arrangement within (or partly within, or as part of) the food waste disposer of the food waste disposer system. Given such an arrangement, control over whether power is provided to the food waste disposer, or whether the food waste disposer is actuated, can be governed by actuation of an air switch actuator (e.g., button) that is coupled to the power control module within the food waste disposer by an air conduction tube. By employing such an arrangement, control over the food waste disposer as governed by actuation of the air switch actuator can be achieved without any additional power links or cords being employed externally of the food waste disposer to couple the power control module to the food waste disposer. Further, such an arrangement allows for air switch actuator-controlled operation of the food waste disposer regardless of the manner in which the food waste disposer is configured to receive power from an external source.

Additionally, the present inventors have recognized that, in at least some such embodiments, an improved food waste disposer system can further include an electrical outlet situated on the food waste disposer that is coupled to the power control module within the food waste disposer, and to which a plug associated with a power cord of an associated or auxiliary device can be coupled. In such embodiments, whether power is provided to the electrical outlet and correspondingly made available for use by the associated or auxiliary device can also depend upon the actuation status of the power control module. Thus, control over whether power is provided to the associated or auxiliary device, or whether that device is actuated, can be governed by actuation of the air switch actuator coupled to the power control module. By using such an arrangement, the number and complexity of connections among the food waste disposer, air switch arrangement, and associated or auxiliary device can be reduced by comparison with conventional system arrangements employing an aftermarket air switch power control device. Further, such an arrangement allows for air switch actuator-controlled operation of the associated or auxiliary device regardless of the manner in which the food waste disposer is configured to receive power from an external source.

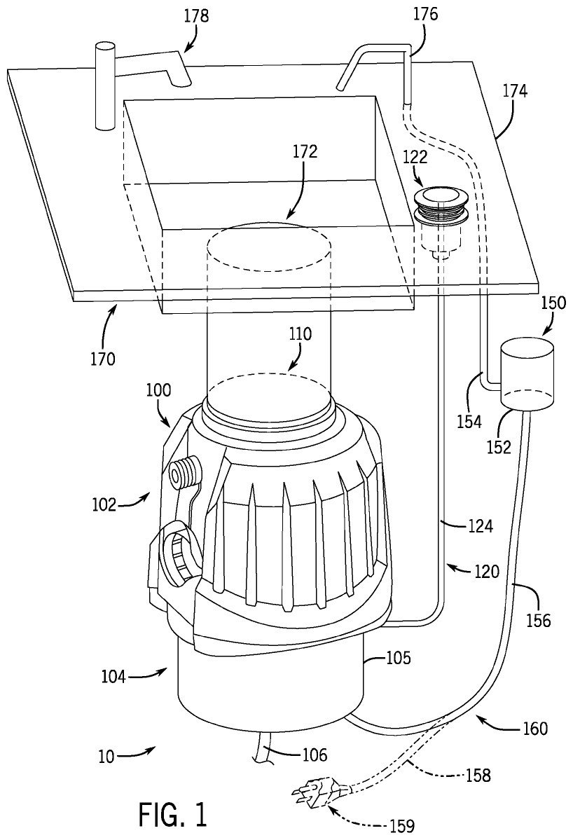

Referring to FIG. 1, a top, substantially front perspective view, respectively, of a food waste disposer system or assembly 10 is shown, in accordance with a first example embodiment encompassed herein. As illustrated, the food waste disposer system 10 includes a food waste disposer 100 having a top housing portion (or enclosure) 102 and a bottom housing portion 104 including a cylindrical stator band 105 and a lower end frame (LEF) 306 (see FIG. 3), where the LEF serves as the disk-shaped bottom surface of the food waste disposer. In general, the food waste disposer 100 can be understood as including a food conveying section, a motor section, and a grinding section. The food conveying section is generally positioned at a location corresponding to the location of the enclosure 102, at or near the top of the food waste disposer 100. The motor section is generally positioned at a location corresponding to and within the stator band 105, at or near the bottom of the food waste disposer 100. The grinding section is disposed between the food conveying section and the motor section.

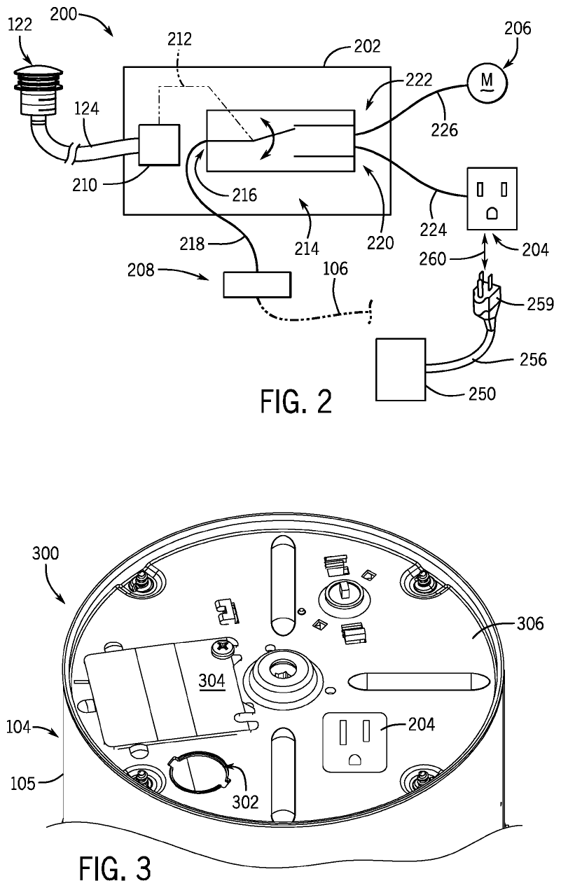

The motor section includes a motor 206 (see FIG. 2) imparting rotational movement to a motor shaft to operate the grinding section. In the present example embodiment, the motor can be an electric motor that is an inductive motor, although the present disclosure is intended to encompass embodiments of food waste disposers employing other types of motors such as permanent magnet motors. Power for operating the motor within the motor section in the present embodiment is communicated to the food waste disposer 100 from an external power source by way of a power link 106 that is coupled to the food waste disposer 100 at a location that in the present embodiment is along the bottom housing portion 104, particularly along the LEF 306 (see FIG. 3), or along the cylindrical stator band 105. The power link 106 can take any of a variety of forms depending upon the embodiment, as discussed in further detail below. As also discussed below, depending upon the embodiment, the power link 106 may or may not be considered to be part of the food waste disposer 100 or the food waste disposer system 10.

In the present example embodiment, the food waste disposer system 10 also includes, in addition to the food waste disposer 100, an air switch mechanism or arrangement 120. Further, in the present illustration, the food waste disposer system 10 is implemented in combination with an auxiliary (or associated) device, which in the present example is a hot water heating device 150. The combination of the food waste disposer system 10 (including the food waste disposer 100 and the air switch mechanism 120) and the hot water heating device 150 can be considered and referred to as a combination system 160. Additionally, each of the food waste disposer 100 and air switch mechanism 120 of the food waste disposer system 10, and also the hot water heating device 150, is further mounted or supported in relation to a sink 170. It should be understood that the sink 170, even though coupled to the food waste disposer system 10, is distinct from and not part of the food waste disposer system.

More particularly, the food waste disposer 100 is coupled to a drain at the bottom of a basin 172 of the sink 170, and it should be appreciated that the food conveying section of the food waste disposer particularly includes an inlet 110 that is coupled to the drain for receiving food waste and fluid (e.g., water), and conveys the food waste to the grinding section of the food waste disposer. Further, the air switch mechanism 120 particularly includes an actuator 122 that is supported on an upper surface 174 of the sink 170 and an air conduction tube 124 that links the actuator 122 to a power control module 202 (see FIG. 2), which in the present embodiment is supported within the food waste disposer 100 (a portion of the air conduction tube that is positioned beneath the sink 170 is shown in phantom). In the present example, the air switch mechanism 120 is considered to be distinct from the food waste disposer 100, with the food waste disposer and air switch mechanism both being included as part of the food waste disposer system 10. However, in other embodiments or contexts, the air switch mechanism 120 (or a portion thereof) can be considered to form a part of the food waste disposer 100 itself.

Additionally as shown, in the present embodiment, the hot water heating device 150 includes a main body (or heating vessel) 152 within which water can be contained and heated, a hot water delivery tube 154, and a power cord 156. The hot water delivery tube 154 is coupled between the main body 152 and a hot water dispensing tap 176 positioned on the sink, which in the present example embodiment is distinct from a faucet 178 also positioned on the sink. Actuating (opening) the dispensing tap 176 allows hot water available in the main body 152 to flow through the hot water delivery tube 154 to and out of the dispensing tap 176. Thus, when the hot water heating device 150 is operating, an operator can cause hot water from the hot water heating device 150 to be delivered to the basin 172 by actuating the dispensing tap 176.

Further as shown, the power cord 156 is coupled between the main body 152 and the food waste disposer 100. It should be understood that the power cord 156, when coupled to the food waste disposer 100 as indicated by FIG. 1, particularly is coupled to an electric socket 204 positioned along the exterior of the food waste disposer 100 (see FIG. 2). Additionally, although FIG. 1 shows the power cord 156 as being coupled to the food waste disposer 100, FIG. 1 also shows by way of phantom lines a portion 158 of the power cord in an alternate position in which the power cord is unplugged from the food waste disposer, so as to reveal a plug 159. The plug 159 particularly is complementary to the electric socket 204 (again see FIG. 2) positioned along the exterior of the food waste disposer 100, and is the portion of the power cord 156 that enables the power cord to be coupled to the food waste disposer by connecting the plug 159 with the electric socket.

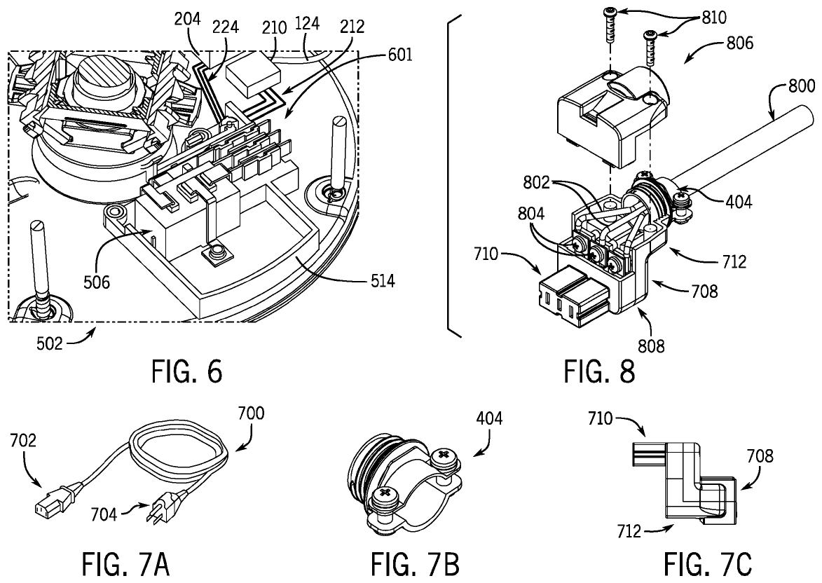

Turning to FIG. 2, a schematic diagram 200 is provided to further illustrate electrical and pneumatic components, and connections among those components, within the food waste disposer system 10 of FIG. 1, including both the food waste disposer 100 and the air switch arrangement 120. The schematic diagram 200 particularly shows that the food waste disposer system 10 includes a power control module 202 that is coupled to each of the actuator 122, an electric socket 204, a motor 206, and a power terminal 208. Although FIG. 2 does not show the food waste disposer 100 of the food waste disposer system 10 in its entirety, it should be understood that the power control module 202 in the present embodiment is mounted within the food waste disposer 100. The power control module 202 can for example be positioned proximate to the motor 206, which is also mounted within the food waste disposer 100 (see, for example, the description provided below in regard to FIG. 6). Additionally, as already mentioned, the electric socket 204 in the present embodiment also is positioned along the exterior of the food waste disposer 100. Further, the power terminal 208 also can be positioned along or proximate to the exterior of the food waste disposer 100.

Additionally, the schematic diagram 200 of FIG. 2 also shows an example auxiliary (or associated) device 250 that can be coupled to the electric socket 204 of the food waste disposer system 10, so as to form an example combination system encompassing both that auxiliary (or associated) device and the food waste disposer system. As described further below, the auxiliary (or associated) device 250 is intended to be representative of any of a variety of one or more auxiliary (or associated) devices that can be coupled to the electric socket 204 of the food waste disposer system 10 so as to receive electric power therefrom, including for example (but not limited to) the hot water heating device 150 of FIG. 1. As shown, the auxiliary (or associated) device 250 particularly includes a power cord 256 with a plug 259 that, in the present embodiment, takes the same form as the plug 159 of FIG. 1. Although the plug 259 of the auxiliary (or associated) device 250 is illustrated as being decoupled from the electric socket 204, nevertheless FIG. 2 also shows that the plug 259 can be plugged into and coupled to the electric socket as indicated by a double-headed arrow 260.

Further as shown in FIG. 2, the power control module 202 more particularly includes an air pressure (or air flow) sensor 210 that is coupled to the actuator 122 by the air conduction tube 124. The air pressure sensor 210 additionally is coupled, within the power control module by a linkage 212, to a dual throw switch 214. Further, an input terminal 216 of the dual throw switch 214 is coupled by a first electrical connector 218 to the power terminal 208. Additionally first and second output terminals 220 and 222 of the dual throw switch 214, respectively, are coupled by second and third electrical connectors 224 and 226, respectively, to the electric socket 204 and the motor 206, respectively.

As described in further detail below, the power terminal 208 can be directly or indirectly coupled to an external power source that is distinct from the food waste disposer system 10 by way of any of a variety of types of power links depending upon the embodiment, as represented by the power link 106. The power link 106 is illustrated in FIG. 2 in cutaway and by a dashed line to indicate that the power link, depending upon the embodiment, may or may not be considered to be a component of the food waste disposer system 10. For example, as described further below, the power link 106 can be a Romex cable or BX cable or hard covered wire (or simply Romex/BX cable) that is hardwired relative to a home or other installation environment and, in such case, the power link 106 is not (or need not be) considered a part of the food waste disposer system 10. Also for example, as described further below, the power link 106 can be a power cord that is considered to be a part of the food waste disposer system 10 and that includes a plug by which the power cord can be plugged into a wall outlet of the home or other installation environment within which the food waste disposer system 10 is being implemented.

In the present embodiment, the status of the dual throw switch 214 is governed by the air pressure sensor 210, due to electrical signals communicated between the air pressure sensor and the switch by way of the linkage 212. When the air pressure sensor 210 senses a sufficient change in air pressure (or in air flow), which can occur when air flows through the air conduction tube 124 toward (or, alternatively, away from) the air pressure sensor due to actuation (e.g., depressing) of the actuator 122, the air pressure sensor communicates a signal to the dual throw switch 214 that causes the switch to toggle back and forth between having a first operational status (or operating in a first operational mode) and having a second operational status (or operating in a second operational mode). Notwithstanding the above description of the air switch mechanism 120 as particularly including the actuator 122 and air conduction tube 124, the air switch mechanism can also be considered (in at least some circumstances) to encompass the power control module 202 with the dual throw switch 214, the air pressure sensor 210, and the linkage 212. Alternatively, the power control module 202 (along with the electric socket 204 and/or the power terminal 208) can be considered to be included as parts of the food waste disposer 100.

When the dual throw switch 214 has the first operational status, input power received at the input terminal 216 from the power terminal 208 (assuming that the power terminal 208 is coupled to an external power source) is communicated through the dual throw switch to each of the electric socket 204 and the motor 206, respectively, by the second electrical connector 224 and the third electrical connector 226, respectively. Thus, in the present embodiment, the first operational status of the dual throw switch 214 results in or corresponds to actuation of the motor 206 as well as provision of power to the electric socket 204. Alternatively, when the dual throw switch 214 has the second operational status, input power received at the input terminal 216 from the power terminal 208 (assuming that the power terminal 208 is coupled to an external power source) is precluded from being communicated through the dual throw switch to the electric socket 204 and the motor 206 by the second electrical connector 224 and the third electrical connector 226, respectively. Consequently, in the present embodiment, the second operational status of the dual throw switch 214 results in or corresponds to deactivation of the motor 206 and decoupling of power from the electric socket 204.

Notwithstanding the above description of how the power control module 202 can operate in response to actuation signals communicated from the actuator 122 via the air conduction tube 124, the power control module 202 in other embodiments can be configured to operate in other manners. For example, in an additional embodiment, one or both of the first and second output terminals 220 and 222 are only coupled to the motor 206, and the power terminal 208 in addition to being coupled to the input terminal 216 of the dual throw switch 214 is also coupled directly (e.g., by way of an additional connector) to the electrical socket 204. In this embodiment, actuation of the actuator 122 causes the dual throw switch 214 to toggle back and forth between having the first operational status and the second operational status in a manner that only affects whether the motor 206 is provided with power and switched on, or not provided with power and switched off. Further, in this embodiment, the electrical socket 204 is always provided with power to the extent that power is available at the power terminal 208. That is, the electrical socket 204 can be powered even when the food waste disposer 100, or the remainder of the food waste disposer and particularly the motor 206 thereof, is not powered.

Also, additional embodiments are intended to be encompassed herein. For example, in a further embodiment, it is the electrical socket 204 that is coupled to one or both of the first and second output terminals 220 and 222 of the dual throw switch 214, and the motor 206 is coupled directly to the power terminal 208. Further, in another embodiment, the power control module 202 employs a different type of switch that has two different operational statuses and that is configured to alternate the providing of power (as received via the power terminal 208), based upon the operational status of the switch, between providing the power to the motor 206 and providing the power to the electrical socket 204 (and any auxiliary or associated device coupled thereto). That is, in such embodiment, when actuation of the actuator 122 causes the switch to have a first operational status, the motor 206 is provided with power (as provided via the power terminal 208) but the electrical socket 204 is not provided with power. However, when actuation of the actuator 122 causes the switch to have a second operational status, the electrical socket 204 is provided with power but the motor 206 is not provided with power. Such a switching arrangement can be appropriate for certain types of combination systems (such as when the auxiliary or associated device is the hot water heating device 150) in which it is acceptable for power to the auxiliary (or associated) device to be switched off for relatively short amounts of time during which power is provided to the motor 206 of the food waste disposer 100.

Additionally, in yet another embodiment, the power control module 202 can have a different type of switch other than the dual throw switch 214, and can take on more than two operational statuses. In such an embodiment, further for example, the power control module 202 can provide power both to the electrical socket 204 and to the motor 206 when the power control module has a first operational status, the power control module can provide power to only the electrical socket 204 (or, alternatively, only to the motor 206) when the power control module has a second operational status, the power control module can provide power to only the motor (or, alternatively, only to the electrical socket 204) when the power control module has a third operational status, and the power control module can decouple power from each of the electrical socket and the motor when the power control module has a fourth operational status. Further, in an additional embodiment, the power control module 202 can provide power both to the electrical socket 204 and to the motor 206 when the power control module has a first operational status, the power control module can provide power to only one of the electrical socket 204 and motor 206 when the power control module has a second operational status, and the power control module can decouple power from each of the electrical socket and the motor when the power control module has a third operational status.

Referring additionally to FIG. 3, a bottom perspective cutaway view of a bottom section 300 of the food waste disposer 100 of the food waste disposer system 10 is further provided. The bottom section 300 shown in FIG. 3 particularly includes the bottom housing portion 104, including part of the cylindrical stator band 105 and the LEF 306, in a manner that is independent of the sink 170 and the hot water heating device 150 and associated power cord 156 of FIG. 1. Given the absence of the power cord 156, the electric socket 204 provided along the LEF 306 particularly is visible. Additionally, in the view provided by FIG. 3, the food waste disposer 100 is shown without being coupled to, or having, any power link by which the food waste disposer system can receive electric power from an external power source. That is, the power link 106 shown in FIG. 1 is not shown in FIG. 3. At the same time, it can be seen that the LEF 306 does include an orifice 302, as well as a terminal cover 304, one or both of which (depending upon the embodiment) can be utilized to allow for a power link to be received by and coupled to the food waste disposer.

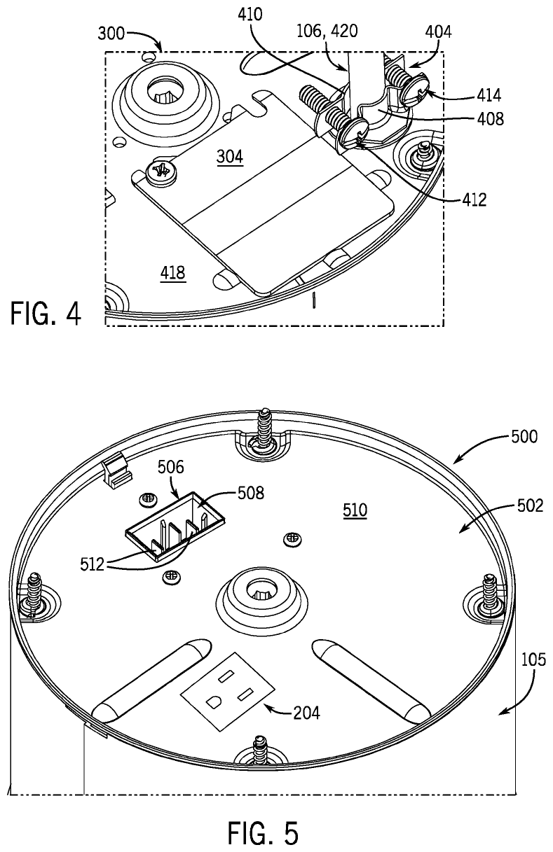

Further in this regard, FIG. 4 shows a bottom perspective cutaway view of the bottom section 300 of the food waste disposer 100 also shown in FIG. 3, which (consistent with FIG. 1) also shows the power link 106. In this example embodiment, the power link 106 particularly takes the form of a Romex/BX cable 420. As shown, the Romex/BX cable 420 particularly is coupled to the food waste disposer 100 by a Romex/BX coupler 404 (see also FIG. 7B), which can be inserted into the orifice 302 of the LEF 306, inwardly from a bottom surface 418 of the LEF, so as to be affixed to the LEF 306. The Romex/BX coupler 404 can be (but need not be) considered part of the food waste disposer 100. As illustrated, the Romex/BX coupler 404 includes first and second surface portions 408 and 410, respectively, as well as first and second screws 412 and 414, respectively, where the screws link the two surface portions and can cause those surface portions to become closer to or farther from one another depending upon the positioning of the screws. The Romex/BX coupler 404 particularly is secured to the Romex/BX cable 420 by tightening the screws 412 and 414.

With such an arrangement, it should be appreciated that wire lead wires (or wire leads or ends) of the Romex/BX cable 402 extend into the interior of the food waste disposer 100, such that those lead wires can be coupled to a terminal corresponding to the power terminal 208 of FIG. 2. Such a terminal in the present embodiment particularly can be formed by one or more wire leads extending from the power control module 202. The manner of installation by which such wire leads extending from the power control module 202 are coupled to the lead wires of the Romex/BX cable 402 can include process steps that are the same or substantially similar to those described in relation to FIGS. 3 and 4A-4L of U.S. patent application publication no. 2021/0087801 published on Mar. 25, 2021 (and corresponding to U.S. patent application Ser. No. 17/025,245 filed on Sep. 18, 2020) and entitled “System and Method for Enabling Waste Disposer to be Coupled to Alternative Electric Power Sources,” which is hereby incorporated by reference herein—provided that the wire leads of the power control module 202 of the present disclosure are substituted for the motor wire leads described in that patent application publication.

Notwithstanding the description provided above in regard to FIGS. 3 and 4, the present disclosure envisions numerous other embodiments of food waste disposer systems (as well as numerous other types of waste disposer systems) that include both food waste disposers (or other types of waste disposers) and also include air switch mechanisms such as the air connection mechanism 120. Depending upon the embodiment, the manner in which the respective food waste disposer system is coupled to receive power from an external source can take any of a variety of different forms. For example, in some other embodiments encompassed herein, the food waste disposers are configured to be coupled to an external power source by way of a different form of the power link 106, namely, a power cord having a plug that is suitable to be plugged into a wall outlet of a home or other installation environment. Such a food waste disposer can include an additional socket or receptacle formed on the exterior of the bottom housing portion to which can be connected one end of the power cord, and the power cord can also have, at its other end, the plug that is suitable to be plugged into the wall outlet. The additional socket or receptacle formed on the exterior of the bottom housing portion can serve as the power terminal 208 (see FIG. 2). Such a power cord serving as the power link 106 can be (but need not be) considered to form part of the food waste disposer to which it is connected.

In at least some of the embodiments encompassed herein, the food waste disposers and/or the associated system components and features are particularly configured to facilitate each of corded installation and hardwired installation—that is, configured to make both corded installation and hardwired installation of the same waste disposer easy for an installer. Referring particularly to FIG. 5, a bottom perspective cutaway view is provided of an alternate embodiment of a bottom section 500 (differing from the bottom section 300) that can instead (that is, instead of the bottom section 300) be a part of the food waste disposer 100 of FIG. 1. In this embodiment, the food waste disposer is configured so that it can be installed in a home or other installation environment so as to receive electric power, in either of two alternative manners depending upon whether the home includes a Romex/BX cable or a wall outlet. FIG. 5 shows the bottom section 500 of the food waste disposer in a manner illustrative of how it would be received by the customer. The bottom section 500 in this embodiment includes a LEF 502 of the food waste disposer as well as portions of the stator band 105 (which can be the same as shown in FIGS. 1 and 3) that circumferentially surrounds the LEF.

Referring still to FIG. 5, and additionally to FIG. 6, which shows a top perspective view of a portion of the LEF 502 (and associated components), the LEF 502 includes an appliance inlet power cord connection structure 506, which can be or include a modified C14 type appliance inlet. In the present embodiment, the appliance inlet power cord connection structure 506 can take the form of a receptacle having an opening 508 along a bottom surface 510 of the LEF 502 that is configured to receive a modified C13 type plug, and that is configured to allow for electrical power to be communicated from that plug to electrical coupling prongs 512 extending within the receptacle (see particularly FIG. 5). Additionally with reference to FIG. 2, the appliance inlet power cord connection structure 506 can be considered to constitute the power terminal 208. In addition to the appliance inlet power cord connection structure 506, the LEF 502 also includes the electrical socket 204. The electrical socket 204 faces outward from the bottom surface 510 of the LEF 502 as shown in FIG. 5, so as to be able to receive a plug therein. Both of the appliance inlet power cord connection structure 506 and the electrical socket 204 are visible in FIG. 5 (providing an exterior view) and in FIG. 6 (providing an interior view).

Further with respect to FIG. 6, it should also be appreciated that the appliance inlet power cord connection structure 506 is part of a larger structure that is an induction motor start switch module 514. The induction motor start switch module 514 is accessible through an opening in the LEF 502, and has a set of terminals to allow for easy electrical connection to the motor stator during the manufacture and assembly of the disposer (FIG. 6 shows terminals 601 that are for a cluster block connector from a motor). In the present embodiment, the induction motor start switch module 514 can be understood to include the dual throw switch 214 (see FIG. 2) of the power control module 202 (see FIG. 2). Further, FIG. 6 also shows the air pressure sensor 210, a portion of the air conduction tube 124 by which the air pressure sensor is coupled to the actuator 122 (see FIGS. 1 and 2), the linkage 212 by which the air pressure sensor is coupled to the dual throw switch (within the induction motor start switch module 514), and the second electrical connector 224 by which the dual throw switch is coupled to the electrical socket 204. It should be understood that the third electrical connector 226 is provided as part of (or within) the induction motor start switch module and, for example, can include or be formed by the terminals (e.g., the terminals 601) allowing for electrical connection to the motor stator. Thus, in the embodiment of FIG. 5 and FIG. 6, the combination of the induction motor start switch module 514 (or a portion thereof) and the air pressure sensor 210 (and related connections/links such as the linkage 212) can be considered to correspond to and form the power control module 202.

Turning to FIGS. 7A, 7B, and 7C, the food waste disposer with the bottom section 500 including the LEF 502 shown in FIGS. 5 and 6 includes, or can be installed in conjunction with, system components that permit the food waste disposer to achieve either corded installation or hardwired installation depending upon whether the environment (e.g., home kitchen) within which the food waste disposer is being installed includes an electrical wall outlet or a Romex/BX cable. As will be described in further detail below, these system components can be considered to be alternative system components, in that one or more of the system component(s) can be implemented to achieve corded installation and one or more other(s) of the system component(s) can be implemented to achieve hardwired installation.

More particularly, FIG. 7A shows a power cord 700 that particularly allows for corded installation in an environment in which there is an electrical wall outlet. As shown, the power cord 700 includes a modified C13 type plug 702 at a first end of the cord and a NEMA 5-15 plug 704 at a second (e.g., opposite) end of the cord. Corded installation of the food waste disposer having the bottom section 500 can be achieved using the power cord 700 simply by plugging the modified C13 type plug 702 into the appliance inlet power cord connection structure 506, and by plugging the NEMA 5-15 plug 704 into the electrical wall outlet (not shown). By comparison, FIG. 7B shows the Romex/BX (or simply Romex) coupler 404 already discussed above in regard to FIG. 4, and FIG. 7C shows a Romex/BX adapter with custom plug (or simply Romex adapter) 708, which includes both a modified C13 type plug 710 on a first side (or end) of the adapter and a Romex/BX coupling assembly 712 on a second side (or end) of the adapter. The Romex coupler 404 in the present embodiment can take the form of a commonly available electrical component typically used to ground metallic sheathed cable (BX) and/or secure the Romex/BX cable to another component (e.g., to an electrical outlet box or an adapter).

As further illustrated by FIG. 8, in an installation environment in which a Romex/BX cable 800 is present, an installer can pass an end of the Romex/BX cable through the Romex coupler 404 and attach lead wires 802 extending from an end if that Romex/BX cable to screws 804 of the Romex/BX coupling assembly 712. Additionally, as should be evident from FIG. 8, which provides a partly-exploded view of the Romex/BX coupling assembly 712 in which a cover portion 806 is exploded from a remainder portion 808 of that coupling assembly, the Romex coupler 404 can be attached to/retained in relation to the Romex/BX coupling assembly 712 when the cover portion 806 is assembled to the remainder portion 808 (e.g., by way of screws 810). When the Romex/BX cable 800 is fully assembled to the Romex adapter 708, electrical installation of the food waste disposer having the bottom section 500 can be achieved simply by plugging the modified C13 type plug 710 of the Romex adapter 708 into the appliance inlet power cord connection structure 506. In this arrangement, the combination of the appliance inlet power cord connection structure 506 and the Romex adapter 708 can be considered to constitute the power terminal 208.

The present disclosure is also intended to encompass further embodiments and modified versions of the above-described embodiments in addition to the embodiments specifically described above. Among other things, although the above description relates to food waste disposers, the present disclosure is also intended to encompass embodiments relating to other types of waste disposers. Also, notwithstanding the description above, the present disclosure is intended to encompass any of a variety of other types of arrangements by which a food waste disposer of a food waste disposer system (or a waste disposer of another type of waste disposer system) is coupled to an external power source to receive electrical power. Also, the present disclosure is intended to encompass any of a variety of different types of food waste disposers or other waste disposers employing any of a variety of types of motors, for example, including permanent magnet motors in addition to induction motors.

Further, the present disclosure is intended to encompass any of a variety of types of terminals, sockets, plugs, connectors, and other features allowing for various components, structures, and devices to be coupled or in communication with one another, either electrically or pneumatically. For example, depending upon the embodiment, any of a variety of wire joiner connectors, standard wire nuts, or other connectors or fasteners can be employed to join various conductors. Any one or more of such components can be considered, in at least some embodiments, to form part of a terminal or power terminal such as the power terminal 208. Additionally for example, although the electrical socket 204 is shown to be positioned on the LEFs 306 and 502 in FIGS. 3 and 5, respectively, in other embodiments the electrical socket can be situated along any of a variety of other housing surfaces of a food waste disposer, such as along the stator band (e.g., along the stator band 105 in FIG. 1) or along the top housing portion (e.g., on the top housing portion 102 in FIG. 1). Further for example, in additional embodiments, multiple electrical sockets each being of the type of the electrical socket 204 or one or more other types of electrical sockets can be situated along one or more housing surfaces of the food waste disposer, where each of those electrical sockets are provided with power as governed by a power control module.

Also, although the present disclosure envisions embodiments in which a food waste disposer assembly is coupled to a wall outlet by way of a power cord having a plug such as a NEMA 5-15 plug, the present disclosure is also intended to encompass other embodiments that include or operate in conjunction with other types of connectors, plugs, and adapters, including for example C-13 or C14 sockets or plugs. Additionally, among other things, the present disclosure is intended to encompass all of the subject matter disclosed in each of the aforementioned U.S. patent application publication no. 2021/0087801 published on Mar. 25, 2021 and also U.S. patent application publication no. 2021/0238834 published on Aug. 5, 2021 (and corresponding to U.S. patent application Ser. No. 17/165,518 filed on Feb. 2, 2021) and entitled “System and Method for Enabling Waste Disposer With Permanent Magnet Motor to be Coupled to Alternative Electric Power Sources,” both of which are incorporated by reference herein.

Further, as discussed above with respect to FIG. 1, in one example embodiment the food waste disposer system 10 is implemented in combination with an auxiliary (or associated) device, which in the present example is a hot water heating device 150, so as to form the combination system 160. Nevertheless, as also discussed above in regard to the auxiliary (or associated) device 250 shown in FIG. 2, the present disclosure encompasses numerous other combination systems in addition to the combination system 160 that include both a food waste disposer system (such as the food waste disposer system 10) and any of a variety of one or more other auxiliary (or associated) devices instead of, or in addition to, the hot water heating device 150. In any of such other combination devices, the one or more auxiliary (or associated) devices (again represented generally by the device 250) can be coupled to the electric socket 204 to receive power therefrom.

For example, such other auxiliary (or associated) devices can include an additional hot water heating device, a water cooling device, a light device, or a fan device. Additionally for example, such other auxiliary (or associated) devices can include a disposer fluid injector system fluidly connected to the food waste disposer 100 (e.g., to a dishwasher inlet thereof) and configured to inject fluid(s) into the food waste disposer. Also for example, such other auxiliary (or associated) devices can include any of a number of other appliances such as kitchen appliances or cleaning (or housekeeping) appliances that can require electric power. Such other appliances can include, further for example, refrigerators or chillers (e.g., beverage or wine chillers), microwave ovens, dishwashers, coffee makers, blenders or mixers, toasters or toaster ovens, bread makers, waffle irons, vacuum cleaners, humidifiers or dehumidifiers, or air purifiers. Additionally for example, such other auxiliary (or associated) devices can include consumer electronics devices for which electrical power can be sought, such as televisions, computers, or electrical recharging devices (e.g., rechargers for mobile devices). Further for example, such other auxiliary (or associated) devices can include devices such as electric tools (e.g., an electric drill or flashlight) that are employed by plumbers, electricians, other tradespersons, or other users (e.g., a homeowner or an installer) to accomplish various goals or tasks at locations proximate to the food waste disposer system 10, such as under the sink in regard to which the food waste disposer system is implemented or within the kitchen or other room in which the food waste disposer system is generally positioned.

Further, it should be appreciated that the present disclosure also encompasses combination systems in which multiple ones of any of such auxiliary (or associated) devices can be coupled to, and receive electric power from, the electric socket 204. For example, in some embodiments encompassed herein, multiple auxiliary (or associated) devices are coupled to the electric socket 204 by a power strip (or, alternatively, by a power splitter or plug splitter) having a plug that is plugged into the electric socket 204 and additionally having multiple outlets with respect to which respective ones of the auxiliary (or associated) devices are coupled to receive power. Such an arrangement can be understood to be a combination system having multiple auxiliary (or associated) devices or, alternatively, a combination system having a single auxiliary (or associated) device that encompasses each of multiple devices that are coupled to the power strip (as well as the power strip itself). Additionally, the present disclosure is not limited to combination systems in which one or more auxiliary (or associated) devices that are coupled to receive power from the electric socket 204 are located proximate to (e.g., within the same room as) the electric socket. Rather, the present disclosure also envisions combination systems in which one or more auxiliary (or associated) devices are located remotely from the electric socket 204 but are coupled to the electric socket directly or indirectly by an extension cord or other connecting linkage(s), possibly in combination with a power strip or power splitter/plug splitter if multiple auxiliary or associated devices are to receive power.

The present disclosure is intended to encompass numerous additional embodiments having one or more features or components that are in addition to, or differ from, the features or components of the embodiments described above or elsewhere herein. For example, notwithstanding the description herein of one or more plugs or sockets that take the form of a modified C14 type appliance inlet, modified C13 type plug, or a NEMA 5-15 plug, the present disclosure is intended to encompass numerous other types of plugs, interfaces, connectors, and/or other engaging or complementary structures that allow for electrical connections to be established or maintained. Further for example, although the electric socket 204 and plugs 159, 259 described at several locations herein are respectively illustrated as taking female and male forms, respectively, the present disclosure also encompasses embodiments in which the electrical socket takes a male form and the interfacing plug(s) take a female form.

The present disclosure also includes a variety of different manners of operation and control as determined by a power control module such as (but not limited to) the power control module 202, at least in part as determined by an air switch mechanism such as the air switch mechanism 120. In some embodiments, an electric socket such as the electric socket 204, to which one or more auxiliary (or associated) devices can be coupled to receive power, always receives power so long as power is provided to the food waste disposer system from an external power source. However, in other embodiments, such an electric socket receives power when the power control module has one operational status but not when the power control module has another operational status. Likewise, in some embodiments, a motor such as the motor 206 always receives power so long as power is provided to the food waste disposer system from an external power source. However, in other embodiments, such a motor is provided with power when the power control module has one operational status but not when the power control module has another operational status. Additionally, in at least some embodiments encompassed herein, an electric socket such as the electric socket 204 is provided with power at all times when power is provided to the food waste disposer system (or a power control module therein) from an external power source, regardless of when a motor such as the motor 206 (or regardless of when a waste disposer of which the motor forms a part) is powered or provided with power or actuated.

Further, the present disclosure is intended to encompass other types of air switch mechanisms and/or other switching or control mechanisms that involve other components and/or different manners of operation than the air switch mechanisms such as the air switch mechanism 120 described above. For example, in some embodiments, a power control module can have a normal state and an actuated state, and signals communicated by the air switch mechanism in response to user actuation of an actuator can cause the power control module to switch from the normal state to the actuated state and/or back again to the normal state. Also, the present disclosure is intended to encompass numerous different types of air switch mechanisms having any of a variety of types of actuators or actuation mechanisms.

Further, the present disclosure is also intended to encompass numerous other types of control or switching mechanisms including wireless control or switching mechanisms that involve electromagnetic communications (e.g., by way of radio waves), for example, between an actuator and a power control module. For example, in at least some additional embodiments encompassed herein, a power control mechanism is connected, at least indirectly, with an actuation button or other actuator by one or more communication linkage(s) that may include one or more wired (e.g., electrical) communication linkage(s) and/or one or more wireless communication linkage(s), instead of (or, alternatively, in addition to) any air conduction tube. In such additional embodiments, the power control module is configured to respond to one or more signal(s) communicated via the one or more communication linkage(s), further for example, by switching between at least a first operational status and a second operational status in response to the signal(s). To the extent that the signal(s) communicated between the actuator and the power control module are electrical or wireless signal(s) rather than signals involving air pressure or air flow, the power control module need not include any air pressure sensor. Rather, in such an embodiment, the actuator can be configured to generate or communicate (when pressed or otherwise actuated) such electrical or wireless signals rather than air pressure or air flow changes, and the power control module can be configured to respond to such electrical or wireless signals.

It is specifically intended that the present invention not be limited to the embodiments and illustrations contained herein, but include modified forms of those embodiments including portions of the embodiments and combinations of elements of different embodiments as come within the scope of the following claims.

We claim:

1. A food waste disposer system comprising:
a housing including a bottom housing portion and a top housing portion;
a power control module supported at least partly within the housing;
a motor supported within the housing and coupled electrically, at least indirectly, to the power control module;
an actuator;
at least one communication linkage connecting the actuator with the power control module; and
an electrical socket supported along the bottom housing portion and coupled electrically, at least indirectly, to the power control module;
wherein either the bottom housing portion or the power control module is further configured to receive a first power link that extends outward from the housing, so that the power control module is coupled electrically, at least indirectly, to a first end of the first power link,
wherein the power control module is configured to respond to at least one signal communicated via the at least one communication linkage occurring as a result of an actuation of the actuator, and further configured to switch between at least a first operational status and a second operational status in response to the at least one signal,
wherein first electric power received via the first power link is communicated from the first power link via the power control module to the motor when the power control module has the first operational status, but not communicated from the first power link via the power control module to the motor when the power control module has the second operational status, and
wherein second electric power received via the first power link is communicated from the first power link via the power control module, at least indirectly, to the electrical socket at least when the power control module has the second operational status.

2. The food waste disposer system of claim 1, wherein the second electric power received via the first power link is communicated from the first power link via the power control module, at least indirectly, to the electrical socket both when the power control module has the first operational status and also when the power control module has the second operational status.

3. The food waste disposer system of claim 2, wherein the second electric power received via the first power link is communicated from the first power link via the power control module, at least indirectly, to the electrical socket both when the power control module has the first operational status and also when the power control module has the second operational status, but is not communicated from the first power link via the power control module to the electrical socket when the power control module has a third operational status.

4. The food waste disposer system of claim 1, further comprising a food waste disposer including the housing, the motor, the power control module, and the electrical socket,
wherein the actuator includes an actuation button positioned externally of the housing,
wherein the at least one communication linkage includes an air conduction tube connecting the actuation button at least indirectly with the power control module,
wherein the at least one signal communicated via the at least one communication linkage includes an air flow or an air pressure communicated through the air conduction tube,
wherein the power control module is further configured to switch between the first operational status and the second operational status in response to the air flow or air pressure, and
wherein the actuation button is configured to be coupled to or mounted upon a sink, and wherein the air conduction tube couples the food waste disposer with the actuation button.

5. The food waste disposer system of claim 1, wherein either:
(a) the at least one communication linkage includes one or more wireless or electromagnetic communication linkages; or
(b) the food waste disposer system further comprises one or more control or switching mechanisms by which the power control module communicates with the actuator.

6. The food waste disposer system of claim 1,
wherein the power control module is supported within the housing,
wherein the bottom housing portion is further configured to receive the first power link that extends outward from the housing, so that the power control module is coupled electrically, at least indirectly, to the first end of the first power link, and
wherein the first power link is one of a Romex cable or a BX cable.

7. The food waste disposer system of claim 1, wherein the first power link is a power cord that extends from the first end to a second end at which the power cord includes a plug suitable for being coupled to a wall outlet.

8. The food waste disposer system of claim 7, wherein the food waste disposer system comprises the power cord including the plug, and wherein the plug is a NEMA-type plug.

9. The food waste disposer system of claim 1, wherein the food waste disposer system is configurable so that, in a first configuration, the first power link received by the housing includes one of a Romex cable and a BX cable and, in a second configuration, the first power link received by the housing includes a power cord having a plug suitable for being coupled to a wall outlet.

10. The food waste disposer system of claim 1, further comprising one or both of a switch module and an interface connector,
wherein the motor is coupled at least indirectly to the first power link by each of the power control module and one or both of the switch module and the interface connector,
wherein the motor is selected from the group consisting of an inductive motor and a permanent magnet motor,
wherein the electrical socket is positioned along a lower end frame (LEF) of the bottom housing portion, and
wherein the electrical socket is configured to receive a complementary plug, and the electrical socket is a NEMA-type socket.

11. A combination system including the food waste disposer system of claim 1 and a device including a main body an additional power link, the additional power link including a power cord having an associated plug, wherein the additional power link extends from the main body to the electrical socket and is coupled to the electrical socket by the associated plug, so that the second electric power received via the first power link is communicated from the first power link via the power control module to the electrical socket and further from the electrical socket via the power cord to the device when the power control module has the first operational status.

12. The combination system of claim 11, wherein the device includes a hot water heating device.

13. A method comprising:
providing a food waste disposer system including
a housing having a bottom housing portion and a top housing portion,
a power control module supported at least partly within the housing,
a motor supported within the housing and coupled electrically, at least indirectly, to the power control module,
an actuator positioned externally of the housing,
at least one communication linkage connecting the actuator with the power control module, and
an electrical socket supported along the bottom housing portion and coupled electrically, at least indirectly, to the power control module,
wherein the power control module is coupled electrically, at least indirectly, to a first end of a first power link that is received either at the bottom housing portion or the power control module and that extends outward from the housing;
receiving first electric power and second electric power at the power control module via the first power link;
in response to an actuation of the actuator, communicating at least one signal via the at least one communication linkage; and
switching between at least a first operational status of the power control module and a second operational status of the power control module at least indirectly in response to the at least one signal,
wherein the first electric power received via the first power link is communicated from the first power link via the power control module to the motor when the power control module has the first operational status, but not communicated from the first power link via the power control module to the motor when the power control module has the second operational status, and
wherein the second electric power received via the first power link is communicated from the first power link via the power control module, at least indirectly, to the electrical socket at least when the power control module has the second operational status.

14. The method of claim 13,
wherein the actuator includes an actuator button,
wherein the at least one communication linkage includes an air conduction tube, and
wherein the at least one signal communicated via the at least one communication linkage includes an air flow or an air pressure communicated through the air conduction tube.

15. The method of claim 14, wherein either:
(a) the second electric power received via the first power link is communicated from the first power link via the power control module, at least indirectly, to the electrical socket both when the power control module has the first operational status and also when the power control module has the second operational status; or
(b) the second electric power received via the first power link is not communicated to the electrical socket when the power control module switches to a third operational status at least indirectly in response to an additional actuation of the actuation button.

16. The method of claim 13, further comprising:
prior to the receiving of the first electric power, coupling a complementary plug, of a power cord serving as an additional power link of a hot water heating device, to the electrical socket, wherein the second electric power is additionally communicated from the electrical socket to the hot water heating device via the power cord.

17. The method of claim 13, further comprising:
prior to receiving the first electric power, either (a) coupling one of a Romex cable or a BX cable to a first location at or proximate to the bottom housing portion, or (b) coupling a power cord that is the first power link between the first location at or proximate to the bottom housing portion and a wall outlet.

18. A waste disposer system including an integrated air switch arrangement, the waste disposer system comprising:
a waste disposer including a housing, a motor supported within the housing, a power control module supported at least partly within the housing, and either a receiving terminal coupled at least indirectly with the power control module by which the waste disposer can be connected to either a Romex cable or a BX cable to receive first electric power, or a first power cord coupled at least indirectly to the power control module by which the waste disposer can be coupled to a wall outlet to receive the first electric power; and
an actuator and an air conduction tube linking the actuator with the power control module, wherein the power control module includes at least one sensor by which the power control module can detect a change in air flow or air pressure as communicated by the air conduction tube in response to an actuation of the actuator and, upon detecting the change, switch between a first operational mode and a second operational mode;
wherein when the power control module is in the first operational mode and the first electric power is received by the waste disposer by either the receiving terminal or the first power cord, the first electric power is communicated at least indirectly by the power control module to both the motor and an additional structure included by the waste disposer, but when the power control module is in the second operational mode, the first electric power is not communicated by the power control module to at least one of the motor or the additional structure.

19. The waste disposer system of claim 18, wherein the additional structure is an electrical socket arranged along an outer surface of the housing and coupled to the power control module, and wherein either:
(a) when the power control module is in the first operational mode and the first electric power is received by the waste disposer by either the receiving terminal or the first power cord, the first electric power is communicated at least indirectly by the power control module to the motor and to the electrical socket, but when the power control module is in the second operational mode, the first electric power is not communicated by the power control module to the motor but still is communicated by the power control module to the electrical socket; or
(b) when the power control module is in a third operational mode the first electric power is not communicated by the power control module to the electrical socket.

20. A combination system comprising the waste disposer system of claim 18, wherein the additional structure is an electrical socket arranged along an outer surface of the housing and coupled to the power control module, and further comprising:
a device having a main body and an additional power cord extending from the main body to a plug, wherein the plug is plugged into the electrical socket,
wherein, when the power control module is in the first and second operational modes, the first electric power is further communicated from the electrical socket to the device by the plug.
